(19) United States
(12) Patent Application Publication
(10) Pub. No.: US 2025/0287278 A1
(43) Pub. Date: Sep. 11, 2025

(54) METHOD AND APPARATUS FOR HANDOVER

(71) Applicant: Samsung Electronics Co., Ltd., Suwon-si, Gyeonggi-do (KR)

(72) Inventors: Lixiang XU, Beijing (CN); Yu PAN, Beijing (CN); Hong WANG, Beijing (CN); Weiwei WANG, Beijing (CN)

(21) Appl. No.: 18/859,392

(22) PCT Filed: Apr. 24, 2023
(86) PCT No.: PCT/KR2023/005544

§ 371 Date: Oct. 23, 2024

(30) Foreign Application Priority Data
Apr. 24, 2022 (CN) 202210435582.0

(51) Int. Cl. H04W 36/08; H04L 5/00; H04W 36/00

(52) U.S. Cl. CPC H04W 36/083; H04L 5/0044; H04W 36/0072

(57) ABSTRACT

The disclosure relates to a 5G or 6G communication system for supporting a higher data transmission rate. A method performed by a source master node (MN), is provided. The method includes receiving information that a direct data forwarding path between a source secondary node (SN) and a target MN is available, or information that a direct data forwarding path between the source SN and a target SN is available, or information that both the direct data forwarding path between the source SN and the target MN and the direct data forwarding path between the source SN and the target SN are available; and determining whether to allocate information of a data forwarding tunnel between the target SN and the source MN for a bearer terminated at the target SN.

### TECHNICAL FIELD

The present application relates to wireless communication technology, in particular to method and apparatus for handover.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance handover in wireless communication system.

### Solution to Problem

A method for supporting handover according to the disclosure can solve a problem about whether to perform direct data forwarding or indirect data forwarding in a process of handover from dual-connectivity to dual-connectivity, ensure coordinated work of a source master base station, a source secondary base station, a target master base station, a target secondary base station and a core network, reduce data loss, reduce data interruption time, improve data forwarding efficiency and ensure service continuity.

According to an aspect of the disclosure, there is provided a method performed by a first node, including:
receiving information that a direct data forwarding path between a second node and a third node is available, or information that a direct data forwarding path between the second node and a fourth node is available, or information that both the direct data forwarding path between the second node and the third node and the direct data forwarding path between the second node and the fourth node are available; and determining whether to allocate information of a data forwarding tunnel between the second node and the first node for a bearer terminated at the second node.

In some implementations, the method further includes: receiving indication information of termination at the third node and/or indication information of termination at the fourth node sent by the third node to obtain whether the bearer terminated at the second node is terminated at the third node or at the fourth node on a target side.

In some implementations, the method further includes: sending, by the first node, data forwarding tunnel information to the second node for data forwarding by the second node.

In some implementations, the method further includes: sending identification of the first node and identification of the second node to the third node for the third node to determine whether direct data forwarding between the third node and the second node is available, and for the fourth node to determine whether direct data forwarding between the fourth node and the first node is available and whether direct data forwarding between the fourth node and the second node is available.

According to an aspect of the disclosure, there is provided a method performed by a third node, including: receiving information that a direct data forwarding path between a fourth node and a first node is available, or information that a direct data forwarding path between the fourth node and a second node is available, or information that both the direct data forwarding path between the fourth node and the first node and the direct data forwarding path between the fourth node and the second node are available sent by the fourth node; and determining whether to allocate information of a data forwarding tunnel between the first node and the third node for a bearer terminated at the fourth node.

In some implementations, the method further includes: sending indication information of termination at the third node and/or indication information of termination at the fourth node to the first node for the first node to obtain whether a bearer terminated at the second node is terminated at the third node or at the fourth node on a target side.

In some implementations, the method further includes: receiving identification of the first node and identification of the second node from the first node, and determining whether direct data forwarding between the third node and the second node is available, and sending the identification of the first node and the identification of the second node to the fourth node.

In some implementations, the method further includes: sending, to the first node, information that a direct data forwarding path between the second node and the third node is available, or information that a direct data forwarding path between the second node and the fourth node is available, or information that both the direct data forwarding path between the second node and the third node and the direct data forwarding path between the second node and the fourth node are available.

In some implementations, the method includes: sending, by the third node, the information to the first node through a Target to Source transparent transmitter in a handover request acknowledge message and a handover command message, or directly including the information in the handover request acknowledge message and the handover command message by the third node, or the third node sends the information to the first node through a handover request acknowledge message over an interface with the first node.

According to an aspect of the disclosure, there is provided a method performed by a fourth node, which includes: determining whether direct data forwarding between the fourth node and a first node is available, and determining whether direct data forwarding between the fourth node and a second node is available, and sending information on whether the direct data forwarding is available to a third node.

In some implementations, the method includes: receiving identification of the first node and identification of the second node from the third node, and determining whether a direct data forwarding path between the fourth node and the first node is available; and determining whether a direct data forward path between the fourth node and the second node is available.

According to an aspect of the disclosure, there is provided a first node for supporting handover, which is configured to implement methods regarding the first node proposed in the disclosure.

According to an aspect of the disclosure, there is provided a third node for supporting handover, which is configured to implement methods regarding the third node proposed in the disclosure.

The above-mentioned methods for supporting handover can solve a problem about whether to perform direct data forwarding or indirect data forwarding in a process of handover from dual-connectivity to dual-connectivity, especially data forwarding between a source master base station and a target secondary base station, data forwarding between a source secondary base station and a target secondary base station, and data forwarding between a source secondary base station and a target base station, so as to ensure coordinated work of the source master base station, source secondary base station, target master base station, target secondary base station and core network, avoid influence on the core network, reduce data loss, reduce data interruption time, improve data forwarding efficiency and ensure service continuity.

### Advantageous Effects of Invention

According to various embodiments of the disclosure, tering UE and handling handover in wireless communication system can be efficiently enhanced.

### BRIEF DESCRIPTION OF DRAWINGS

The above-mentioned and additional aspects and advantages of the present application will become more apparent and easy to understand by the following description taken in conjunction with the accompanying drawings, in which:

FIG. 1 shows a system architecture diagram of System Architecture Evolution (SAE) according to an embodiment of the disclosure;

FIG. 2 shows an initial overall architecture diagram of 5G according to an embodiment of the disclosure;

FIG. 3 shows a schematic diagram of a method for supporting handover according to an embodiment of the disclosure;

FIG. 4 shows a schematic diagram of a method for supporting handover according to an embodiment of the disclosure;

FIG. 5 shows a schematic diagram of a first embodiment of a method for supporting handover according to the disclosure;

FIG. 6 shows a schematic diagram of a second embodiment of a method for supporting handover according to the disclosure;

FIG. 7 shows a schematic diagram of a third embodiment of a method for supporting handover according to the disclosure;

FIG. 8 shows a block diagram of a source base station for a method for supporting handover according to an embodiment of the disclosure; and

FIG. 9 shows a block diagram of a target base station for a method for supporting handover according to an embodiment of the disclosure.

### BEST MODE FOR CARRYING OUT THE INVENTION

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The following description with reference to the drawings is provided to facilitate a comprehensive understanding of various embodiments of the present disclosure defined by the claims and their equivalents. This description includes various specific details to facilitate understanding, which should only be considered as exemplary. Therefore, those of ordinary skill in the art will recognize that various changes and modifications can be made to the various embodiments described herein without departing from the scope and spirit of the present disclosure. In addition, for the sake of clarity and conciseness, description of well-known functions and structures may be omitted.

Embodiments of the present application are described in detail below, examples of which are shown in the accompanying drawings, in which the same or similar reference numerals refer to the same or similar elements or elements with the same or similar functions throughout. The embodiments described below with reference to the drawings are exemplary, and are only used to explain the present application, and should not be construed as a limitation of the present application.

Those skilled in the art can understand that the singular forms “a”, “an”, “said” and “the” used herein may also include plural forms unless specifically stated. It should be further understood that the words “comprise”, “comprising”, “include”, and “including” used in the specification of the present application means the presence of said features, integers, steps, operations, elements and/or components, but does not exclude the presence or addition of one or more other features, integers, steps, operations, elements, components and/or groups thereof.

It can be understood by those skilled in the art that unless otherwise defined, all terms (including technical terms and scientific terms) used herein have the same meanings as those commonly understood by those of ordinary skill in the art to which the present application belongs. It should also be understood that terms such as those defined in general dictionaries should be understood to have meanings consistent with those in the context of the prior art, and will not be interpreted with idealized or overly formal meanings unless specifically defined as here.

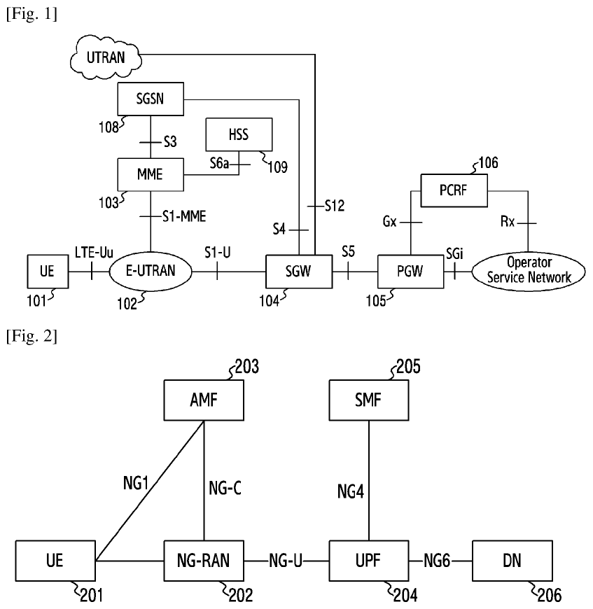

FIGS. 1 to 9 discussed below and various embodiments for describing the principles of the disclosure are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to a 5G core network (5GC), and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity (SMF) 205 is responsible for session management. A data network (DN) 206 includes, for example, services of operators, access of Internet and service of third parties.

When a UE moves between two base stations, in order to ensure service continuity, it is necessary to support data forwarding in a handover process, including intra system handover such as handover between a gNB and a gNB, or handover between a gNB and an eNB connected to 5GC, and inter system handover such as handover between a 5G system (5GS) and an evolved packet system (EPS).

For a handover process where a source side and a target side are both dual-connectivity, there is no scheme about how to decide whether to perform direct data forwarding or indirect data forwarding at present. Dual-connectivity means that the UE accesses a network through two base stations at the same time, one is a master base station (MN) and the other is a secondary base station (SN). The master base station on the source side is a source MN (S-MN), the secondary base station on the source side is a source SN (S-SN), the master base station on the target side is a target MN (T-MN), and the secondary base station on the target side is a target SN (T-SN). The source MN and the source SN are collectively referred to as source nodes, and the target MN and the target SN are collectively referred to as target nodes. The dual-connectivity includes dual-connectivity of the same radio access technology (RAT) and dual-connectivity of different RATs, such as E-UTRA-NR dual-connectivity (EN-DC). The UE accesses a core network through the master base station. A base station seen from the core network is the master base station. Single-connectivity means that the UE only accesses one base station at the same time. The handover from dual-connectivity to dual-connectivity has a problem that the source nodes, including the source MN and the source SN, do not know whether a direct data forwarding path between the source MN and the target SN and a direct data forwarding path between the source SN and the target SN are available, and the source nodes do not know whether each bearer is terminated at the target MN or at the target SN on the target side. The bearer may be a PDU session, a QoS flow or an E-UTRAN Radio Access Bearer (E-RAB). Therefore, during the handover from dual-connectivity to dual-connectivity, the target node allocates a tunnel for data forwarding to the bearer terminated at the node itself, but if there is no interface between the target node and the source node (such as, between the source MN and the target SN, between the source SN and the target MN, or between the source SN and the target SN) at which the bearer is terminated on the source side, data forwarding between the source node and the target node cannot be performed if a data forwarding address allocated by the corresponding node is directly sent to the base station (including the source MN and the source SN) at which the bearer is terminated at the source node, thereby resulting in data loss.

For example, in the process of handover from dual-connectivity to dual-connectivity, if the source master base station sends a tunnel allocated by the target master base station or the target secondary base station for data forwarding to the source secondary base station (SN), but there is no interface between the source secondary base station and the target master base station or between the source secondary base station and the target secondary base station, the data forwarding between the source secondary base station and the target master base station and between the source secondary base station and the target secondary base station cannot be performed, thereby resulting in data loss. Therefore, as for the data forwarding in the handover from dual-connectivity to dual-connectivity, there are still some problems on how to coordinate the source master base station, the source secondary base station, the target master base station, the target secondary base station and the core network currently, and there is no scheme on how to decide whether to use direct data forwarding or indirect data forwarding, especially for the data forwarding between the source master base station and the target secondary base station, between the source secondary base station and the target secondary base station and between the source secondary base station and the target master base station.

The disclosure provides a data forwarding method, which solves the problem about whether to perform direct data forwarding or indirect data forwarding in the process of handover from dual-connectivity to dual-connectivity. In the process of handover from dual-connectivity to dual-connectivity, coordinated work of the source master base station, source secondary base station, target master base station, target secondary base station and core network is ensured, influence on the core network is avoided, data loss is reduced, data interruption time is reduced, data forwarding efficiency is improved and service continuity is ensured.

In the disclosure, a source master base station (source MN) or a source base station may be a first node, a source secondary base station (source SN) may be a second node, a target master base station (target MN) or a target base station may be a third node, and a target secondary base station (target SN) may be a fourth node. This correspondence is only used to explain the present application, but not a limitation thereof.

Exemplary embodiments of the present disclosure are further described below with reference to the accompanying drawings.

The disclosure provides a method for supporting handover.

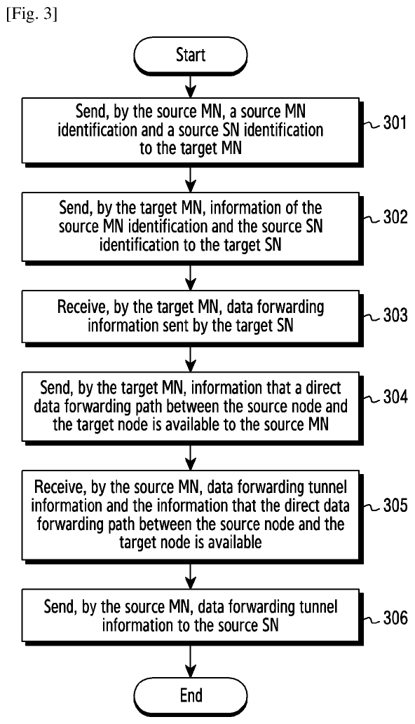

The method may be used for intra system handover or inter-system handover, which is called Method 1. FIG. 3 shows a schematic diagram of an embodiment of the method for supporting handover. The method may be used for a source MN to exchange information with a target MN through a core network, and may also be used for the source MN and the target MN to directly exchange handover (such as Xn handover or X2 handover) related messages. The method includes the following steps.

In step 301, the source MN sends a source MN identification (source MN identity) and a source SN identification (source SN identity) to the target MN. The source MN identification may be any identification information that can uniquely identify the base station directly or indirectly, such as a global base station identifier or a primary cell global identifier. The source SN identification may be any identification information that can uniquely identify the base station directly or indirectly, such as a global base station identifier or a primary secondary cell global identifier. The source MN sends the source MN identification and the source SN identification to the target MN through the core network. The source MN sends the source MN identification and the source SN identification to the target MN through a handover required message from the source MN to the core network and a handover request message from the core network to the target MN. The source MN sends the source MN identification and the source SN identification to the target MN through a Source to Target transparent transmitter in the handover required message and the handover request message, or the source MN directly includes the source MN identification and the source SN identification in the handover required message and the handover request message. Corresponding to Xn or X2 handover, the source MN directly sends the source MN identification and the source SN identification to the target MN, and the source MN sends the information to the target MN through the handover request message.

If there is an interface or a direct forwarding path available between the source MN and the target base station, the handover required message includes Direct Forwarding Path Availability. The core network stores the received Direct Forwarding Path Availability information. When there is an interface between the source MN and the target MN, or the Direct Forwarding Path Availability is included in the handover required message by the source MN, the source MN includes the source MN identification and the source SN identification in the handover required message.

In the disclosure, there are two methods to determine whether a direct data forwarding path between the source SN and the target MN is available. One method is that the source MN sends an identification of the target MN to the source SN, and the source SN determines whether the direct forwarding path between the source SN and the target MN is available, and if it is available, the source SN sends information that direct forwarding paths are available to the source MN; another method is that the source MN sends the source SN identification to the target MN, and the target MN determines whether the direct forwarding path between the source SN and the target MN is available, and if it is available, the target MN informs the source MN of this in step 304.

The target MN receives information of the source MN identification and the source SN identification. The target MN receives information of a bearer to be setup. The information of the bearer to be setup may be E-UTRAN radio access bearer (E-RAB) information or PDU resource configuration information. The PDU resource configuration information includes information of QoS flows to be established, mapping information of QoS flows to data radio bearers (DRBs), and/or downlink data forwarding information for QoS flows.

Corresponding to Method 2 for determining whether a direct data forwarding path between the source SN and the target MN is available, the target MN decides whether there is an interface between the source SN and the target MN or whether there is a secure interface between the source SN and the target MN or whether the direct data forwarding path between the source SN and the target MN is available or whether direct data forwarding between the source SN and the target MN is available. The target MN determines whether the direct data forwarding path between the source SN and the target MN is available according to the received source SN identification.

In step 302, the target MN sends information of the source MN identification and the source SN identification to the target SN. The target MN sends information of a bearer terminated at the target SN on the target side to the target SN. The target MN may send the information to the target SN through a secondary node addition request message. The bearer terminated at the target SN may be an E-RAB terminated at the target SN (target SN terminated E-RAB), a PDU session terminated at the target SN (target SN terminated PDU session), a QoS flow terminated at the target SN (target SN terminated QoS flow), and/or a DRB terminated at the target SN (target SN terminated DRB). “Terminated at a certain node (e.g., source MN, source SN, or target SN) (certain node terminated)” has the same meaning, which is also applied in the following.

Therein, the following description has the same meaning: there is an interface between a source node (source MN and/or source SN) and a target node (target MN and/or target SN); there is a secure interface between the source node and the target node; a direct data forwarding path between the source node and the target node is available; or direct data forwarding between the source node and the target node is available, and the meaning can be substituted for each other. In the following, that a direct data forwarding path between the source node and the target node is available may be used for explanation.

If the target SN accepts downlink data forwarding, the target SN allocates downlink data forwarding tunnel information (information of a downlink data forwarding tunnel). If the target SN proposes uplink data forwarding, the target SN allocates uplink data forwarding tunnel information. The target SN decides whether the direct data forwarding path between the source MN and the target SN is available, and the target SN decides whether the direct data forwarding path between the source SN and the target SN is available. The target SN sends the information that the direct data forwarding path between the source MN and the target SN is available and/or that the direct data forwarding path between the source SN and the target SN is available to the target MN. The target SN may also send information that direct forwarding paths are available, which means that both the direct data forwarding path between the source MN and the target SN and the direct data forwarding path between the source SN and the target SN are available, to the target MN when both the direct data forwarding path between the source MN and the target SN and the direct data forwarding path between the source SN and the target SN are available. The target SN sends downlink data forwarding tunnel information allocated by the target SN and/or uplink data forwarding tunnel information allocated by the target SN (if the target SN proposes uplink data forwarding) to the target MN. The data forwarding tunnel information is per E-RAB, or per PDU session, or per DRB. If the target node is an E-UTRAN node, the data forwarding tunnel is per E-RAB or per DRB. If the target node is a NG-RAN node, the data forwarding tunnel is per PDU session or per DRB.

In step 303, the target MN receives information that a direct data forwarding path between the source node and the target SN is available from the target SN. The information includes the information that the direct data forwarding path between the source MN and the target SN is available and/or the information that the direct data forwarding path between the source SN and the target SN is available provided by the target SN. The target SN may inform the target MN that both the direct data forwarding path between the source MN and the target SN and the direct data forwarding path between the source SN and the target SN are available through one information that direct data forwarding paths are available.

For a bearer terminated at the target SN, if the bearer is terminated at the source MN on the source side, and the direct data forwarding path between the source MN and the target SN is available, the target MN includes the received downlink and/or uplink data forwarding tunnel information allocated by the target SN in a handover request acknowledge message. If the bearer is terminated at the source MN on the source side, and the direct data forwarding path between the source MN and the target SN is unavailable, the target MN allocates information of a data forwarding tunnel from the source MN to the target MN for the bearer, and sends the information of the data forwarding tunnel allocated by the target MN to the source MN. The target MN may directly send the information to the source MN, or send the information to the core network which in turn sends the information to the source MN. According to the information received from the source side, the target MN knows whether the bearer is terminated at the source MN or at the source SN on the source side, which is also applied in the following. The target MN may perform the above operation when it receives the information that direct forwarding paths are available in a handover request message. The information that direct forwarding paths are available being received by the MN in the handover request message means that the direct forwarding path between the source MN and the target MN is available, which is also applied in the following.

For a bearer terminated at the target SN, if the bearer is terminated at the source SN on the source side and both the direct data forwarding path between the source SN and the target SN and the direct data forwarding path between the source MN and the target SN are available, the target MN includes the received downlink data forwarding tunnel information allocated by the target SN and the uplink data forwarding tunnel information allocated by the target SN in the handover request acknowledge message. If the bearer is terminated at the source SN on the source side, and the direct data forward path between the source SN and the target SN is unavailable or the direct data forwarding path between the source MN and the target SN is unavailable, the target MN allocates information of a data forwarding tunnel from the source node to the target MN for the bearer, and sends the information of the data forwarding tunnel allocated by the target MN to the source MN. The target MN may directly send the information to the source MN, or send the information to the core network which in turn sends the information to the source MN. The target MN may perform the above operation when it receives information that direct forwarding paths are available in a handover request message.

For a bearer terminated at the target SN, another process of the target MN is: if the bearer is terminated at the source SN and the direct data forwarding path between the source SN and the target SN is available, the target MN includes the received downlink data forwarding tunnel information allocated by the target SN and uplink data forwarding tunnel information allocated by the target SN in the handover request acknowledge message. If the bearer is terminated at the source SN on the source side, and the direct data forwarding path between the source SN and the target SN is unavailable, the target MN allocates information of a data forwarding tunnel from the source node to the target MN for the bearer, and sends the information of the data forwarding tunnel allocated by the target MN to the source MN. The target MN may directly send the information to the source MN, or send the information to the core network which in turn sends the information to the source MN. The target MN may perform the above operation when it receives the information that direct forwarding paths are available in a handover request message.

For a bearer terminated at the target SN, another process of the target MN is: if the bearer is terminated at the source SN on the source side, and the direct data forwarding path between the source SN and the target SN is unavailable and the direct data forwarding path between the source SN and the target MN is available, the target MN allocates information of a data forwarding tunnel from the source SN to the target MN for the bearer, and sends the information of the data forwarding tunnel allocated by the target MN to the source MN. The target MN may perform the above operation when it receives the information that direct forwarding paths are available in a handover request message.

The target MN decides the bearer terminated at the target MN, and if the target MN accepts downlink data forwarding or the target MN proposes uplink data forwarding, the target MN allocates downlink data forwarding tunnel information. If the target MN proposes uplink data forwarding, the target MN allocates uplink data forwarding tunnel information. The target MN sends the allocated data forwarding tunnel information to the source MN. The target MN may directly send the information to the source MN, or send the information to the core network which in turn sends the information to the source MN.

In step 304, the target MN sends information to the source MN. The information includes a combination of one or more of the following:
information that the direct data forwarding path between the source SN and the target MN is available, information that the direct data forwarding path between the source MN and the target SN is available, information that the direct data forwarding path between the source SN and the target SN is available, and/or information that both the direct data forwarding path between the source MN and the target SN and the direct data forwarding path between the source SN and the target SN are available.
downlink and/or uplink data forwarding tunnel information allocated by the target MN for the bearer terminated at the target MN.
downlink and/or uplink data forwarding tunnel information allocated by the target SN for the bearer terminated at the target SN, or downlink and/or uplink data forwarding tunnel information allocated by the target MN for the bearer terminated at the target SN. Corresponding to the way that the target MN allocates the data forwarding tunnel information for the bearer terminated at the target SN, the data forwarding for the bearer is forwarded from the source node (including the source MN and/or the source SN) to the target SN through the target MN.

The target MN sends the information to the source MN through a handover request acknowledge message from the target MN to the core network and a handover command message from the core network to the source MN. The target MN sends the information to the source MN through a Target to Source transparent transmitter in the handover request acknowledge message and the handover command message, or the target MN directly includes the information in the handover request acknowledge message and the handover command message. Or, the target MN may directly send the information to the source MN, for example, by sending the information to the source MN through a handover request acknowledge message over a Xn or X2 interface. When the target node accepts downlink data forwarding or the target node proposes uplink data forwarding, the target MN includes the information in the handover request acknowledge message and handover command message sent to the core network or the handover request acknowledge message sent to the source MN.

The core network receives the data forwarding tunnel information from the target MN. For direct data forwarding, the core network sends the data forwarding tunnel information received from the target MN to the source MN. If the core network receives or stores the Direct Forwarding Path Availability, the direct data forwarding is available. For indirect data forwarding, the core network allocates data forwarding tunnel information and sends the same to the source MN. For 5GS intra system handover, functions of the core network herein may be performed in an AMF, SMF and/or UPF. For inter system handover from a 4G system to a 5G system, functions of the source core network herein may be performed in an MME entity and SGW. The method of the disclosure does not change function allocation of the core network entities and the support of each core network entity for the data forwarding function, so there is no specific description of each functional entity.

In step 305, the source MN receives the information described in step 304. The information is contained in a handover command message or a handover request acknowledge message. The message includes information that the direct data forwarding path between the source SN and the target MN is available, the direct data forwarding path between the source MN and the target SN is available, the direct data forwarding path between the source SN and the target SN is available, and/or both the direct data forwarding path between the source MN and the target SN and the direct data forwarding path between the source SN and the target SN are available. The information that the direct data forwarding path between the source SN and the target MN is available, the direct data forwarding path between the source MN and the target SN is available, the direct data forwarding path between the source SN and the target SN is available, and/or both the direct data forwarding path between the source MN and the target SN and the direct data forwarding path between the source SN and the target SN are available may be contained in a Target to Source transparent transmitter. That the direct forwarding paths are available means that both the direct forwarding path from the source SN to the target MN and the direct forwarding path from the source SN to the target SN are available.

For a bearer terminated at the source MN, the source MN forwards data according to the received data forwarding tunnel information.

For a bearer terminated at the source SN, if the source MN receives the information that the direct data forwarding path between the source SN and the target MN is available, and the information that the direct data forwarding path between the source SN and the target SN is available or direct data forwarding paths from the target node are available, the source MN sends the received data forwarding tunnel information to the source SN. In this way, the source SN directly forwards data to the target node. The source MN may receive the information that the direct data forwarding path between the source SN and the target MN is available from the source SN or the target MN. For a bearer terminated at the source SN, if there is an interface between the source MN and the target MN or the source MN sends the Direct Forwarding Path Availability to the core network, and the source MN does not receive the information that the direct data forwarding path between the source SN and the target SN is available and/or does not receive the information that the direct data forwarding path between the source SN and the target MN is available and/or does not receive the information that direct forwarding paths are available from the target node, the source MN allocates information of a data forwarding tunnel from the source SN to the source MN, and sends the same to the source SN. That the direct forwarding paths are available means that both the direct forwarding path from the source SN to the target MN and the direct forwarding path from the source SN to the target SN are available. In this way, the source SN forwards data to the source MN which sends the same to the target node.

In step 306, the source MN sends data forwarding tunnel information to the source SN. The source MN may send the information to the source SN through a secondary base station release request message. The data forwarding tunnel information is the data forwarding tunnel information allocated in step 305. The source SN forwards data according to the received data forwarding tunnel information.

So far, the description of Method 1 of the disclosure has been completed. The method can solve a problem about whether to perform direct data forwarding or indirect data forwarding in a process of handover from dual-connectivity to dual-connectivity, especially data forwarding between a source master base station and a target secondary base station, data forwarding between a source secondary base station and a target secondary base station, and data forwarding between a source secondary base station and a target master base station, ensure coordinated work of the source master base station, source secondary base station, target master base station, target secondary base station and core network, avoid influence on the core network, reduce data loss, reduce data interruption time, improve data forwarding efficiency and ensure service continuity.

The disclosure provides another method for supporting handover.

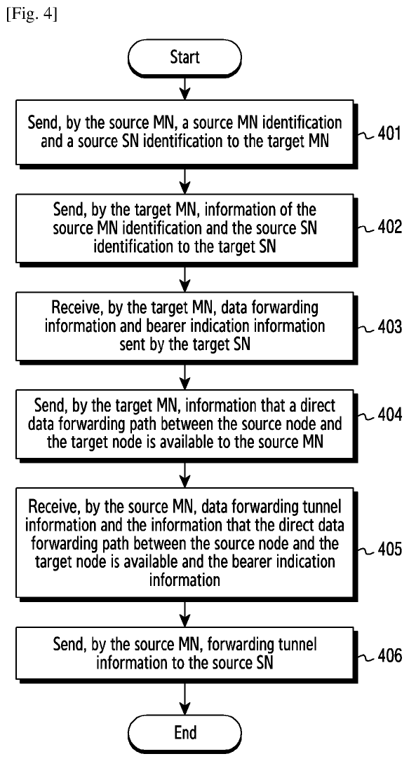

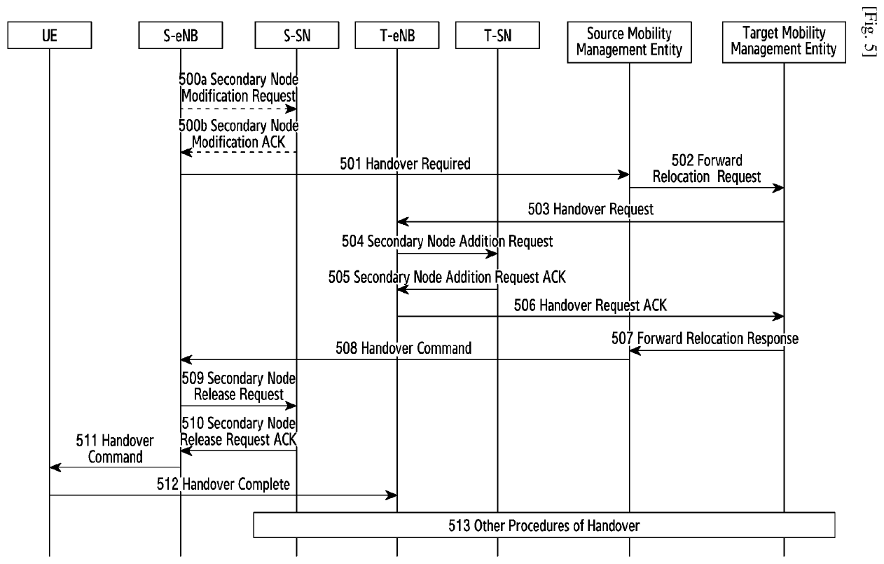

The method may be used for intra-system handover or inter system handover, and is called Method 2. A schematic diagram of an embodiment of the method is shown in FIG. 4. FIG. 4 shows a schematic diagram of a method for supporting handover according to another embodiment of the disclosure.

Steps 401 to 402 are the same as steps 301 to 302, which will not be repeated here.

In step 403, the target MN receives information that the direct data forwarding path of the source node and the target SN is available from the target SN. The information includes information that the direct data forwarding path between the source MN and the target SN is available and/or information that the direct data forwarding path between the source SN and the target SN is available.

For a bearer terminated at the target SN, if the bearer is terminated at the source MN on the source side and the direct data forwarding path between the source MN and the target SN is available, the target MN includes the received downlink and/or uplink data forwarding tunnel information allocated by the target SN in a handover request acknowledge message. If the bearer is terminated at the source MN on the source side, and the direct data forwarding path between the source MN and the target SN is unavailable, the target MN allocates information of a data forwarding tunnel from the source MN to the target MN for the bearer, and sends the information of the data forwarding tunnel allocated by the target MN to the source MN. The target MN may directly send the information to the source MN, or send the information to the core network which in turn sends the information to the source MN. According to the information received from the source side, the target MN knows whether the bearer is terminated at the source MN or at the source SN on the source side, which is also applied in the following. The target MN may perform the above operation when it receives information that direct forwarding paths are available in a handover request message. The information that direct forwarding paths are available being received by the MN in the handover request message means that the direct forwarding path between the source MN and the target MN is available, which is also applied in the following.

For a bearer terminated at the target SN, if the bearer is terminated at the source SN on the source side and the direct data forwarding path between the source SN and the target SN is available or the direct forwarding path between the source MN and the target SN is available, the target MN includes the received downlink data forwarding tunnel information allocated by the target SN and the uplink data forwarding tunnel information allocated by the target SN in the handover request acknowledge message. If the bearer is terminated at the source SN on the source side, and the direct data forward path between the source SN and the target SN is unavailable and the direct data forwarding path between the source MN and the target SN is unavailable, the target MN allocates information of a data forwarding tunnel from the source node to the target MN for the bearer, and sends the information of the data forwarding tunnel allocated by the target MN to the source MN. The target MN may directly send the information to the source MN or send the information to the core network which in turn sends the information to the source MN. The target MN may perform the above operation when it receives the information that direct forwarding paths are available in a handover request message.

For a bearer terminated at the target SN, if the bearer is terminated at the source SN on the source side, and the direct data forwarding path between the source SN and the target SN is unavailable but the direct data forwarding path between the source SN and the target MN is available, the target MN allocates information of a data forwarding tunnel from the source SN to the target MN for the bearer, and sends the information of the data forwarding tunnel allocated by the target MN to the source MN. The target MN may perform the above operation when it receives the information that direct forwarding path are available in a handover request message.

The target MN decides the bearer terminated at the target MN, and if the target MN accepts downlink data forwarding or the target MN proposes uplink data forwarding, the target MN allocates downlink data forwarding tunnel information. If the target MN proposes uplink data forwarding, the target MN allocates uplink data forwarding tunnel information. The target MN sends the allocated data forwarding tunnel information to the source MN. The target MN may directly send the information to the source MN or send the information to the core network which in turn sends the information to the source MN.

In step 404, the target MN sends information to the source MN. The information includes a combination of one or more of the following:
information that the direct data forwarding path between the source SN and the target MN is available, information that the direct data forwarding path between the source MN and the target SN is available, information that the direct data forwarding path between the source SN and the target SN is available, and/or information that both the direct data forwarding path between the source MN and the target SN and the direct data forwarding path between the source SN and the target SN are available.
downlink and/or uplink data forwarding tunnel information allocated by the target MN for the bearer terminated at the target MN.
downlink and/or uplink data forwarding tunnel information allocated by the target SN for the bearer terminated at the target SN, or downlink and/or uplink data forwarding tunnel information allocated by the target MN for the bearer terminated at the target SN. Corresponding to the way that the target MN allocates data forwarding tunnel information for the bearer terminated at the target SN, the data forwarding for the bearer is forwarded from the source node (including the source MN and/or the source SN) to the target SN through the target MN.
indication information of termination at the target MN, and/or indication information of termination at the target SN. The indication information of termination at the target MN and the indication information of termination at the target SN may be per E-RAB, per DRB, per PDU session, and/or per QoS flow.

The target MN sends the information to the source MN through a handover request acknowledge message from the target MN to the core network and a handover command message from the core network to the source MN. The target MN sends the information to the source MN through a Target to Source transparent transmitter in the handover request acknowledge message and the handover command message, or the target MN directly includes the information in the handover request acknowledge message and the handover command message. Or, the target MN may directly send the information to the source MN, for example, by sending the information to the source MN through a handover request acknowledge message over a Xn or X2 interface. When the target node accepts downlink data forwarding or the target node proposes uplink data forwarding, the target MN includes the information in the handover request acknowledge message and handover command message sent to the core network or the handover request acknowledge message sent to the source MN.

The core network receives the data forwarding tunnel information from the target MN. For direct data forwarding, the core network sends the data forwarding tunnel information received from the target MN to the source MN. If the core network receives or stores the Direct Forwarding Path Availability, the direct data forwarding is available. For indirect data forwarding, the core network allocates data forwarding tunnel information and sends the same to the source MN. For an intra 5GS handover, functions of the core network herein may be performed in an AMF, SMF and/or UPF. For an inter system handover from a 4G system to a 5G system, functions of the source core network herein may be performed in an MME entity and SGW. The method of the disclosure does not change function allocation of the core network entities and the support of each core network entity for the data forwarding function, so there is no specific description of each functional entity.

In step 405, the source MN receives information from the target MN, and the information is the same as that in step 404, which will not be repeated here.

According to the indication information of termination at the target MN and/or the target SN, the source MN knows information of the bearer terminated at each target node. Combining with that the direct data forwarding path between the source MN and the target MN is available, the direct data forwarding path between the source MN and the target SN is available, the direct data forwarding path between the source SN and the target MN is available, and/or the direct data forwarding path between the source SN and the target SN is available, the source MN can more accurately determine the data forwarding tunnel of each bearer and provide the optimal data forwarding path to forward data to the target node.

For a bearer terminated at the source MN, the source MN forwards data according to the received data forwarding tunnel information.

For a bearer terminated at the source SN, if the bearer is terminated at the target MN on the target side and the direct data forwarding path between the target MN and the source SN is available, the source MN includes the received downlink and/or uplink data forwarding tunnel information allocated by the target MN in a secondary node release request and sends it to the source SN. If the bearer is terminated at the target MN on the target side, and the direct data forwarding path between the target MN and the source SN is unavailable, the source MN allocates information of a downlink and/or uplink data forwarding tunnel from the source SN to the source MN for the bearer, and includes the information of the downlink and/or uplink data forwarding tunnel allocated by the source MN in the secondary node release request and sends it to the source SN.

For a bearer terminated at the source SN, if the bearer is terminated at the target SN on the target side and the direct data forwarding path between the source SN and the target SN is available, the source MN includes the received downlink and/or uplink data forwarding tunnel information in the secondary node release request and sends it to the source SN. If the bearer is terminated at the target SN on the target side, and the direct data forwarding path between the source SN and the target SN is unavailable but the direct forwarding path between the source SN and the target MN is available, the source MN includes the received downlink and/or uplink data forwarding tunnel information in the secondary node release request and sends it to the source SN. If the bearer is terminated at the target SN on the target side, and the direct data forwarding path between the source SN and the target SN is unavailable and the direct forwarding path between the source SN and the target MN is unavailable, the source MN allocates information of a downlink and/or uplink data forwarding tunnel from the source SN to the source MN for the bearer, and includes the information of the downlink and/or uplink data forwarding tunnel allocated by the source MN in the secondary node release request and sends it to the source SN.

In step 406, the source MN sends the data forwarding tunnel information to the source SN. The source MN may send the information to the source SN through a secondary base station release request message. The data forwarding tunnel information is the data forwarding tunnel information allocated in step 405. The source SN forwards data according to the received data forwarding tunnel information.

So far, the description of Method 2 for supporting handover of the disclosure has been completed. The method can solve a problem about whether to perform direct data forwarding or indirect data forwarding in a process of handover from dual-connectivity to dual-connectivity, ensure coordinated work of the source master base station, source secondary base station, target master base station, target secondary base station and core network, avoid influence on the core network, reduce data loss, reduce data interruption time, improve data forwarding efficiency and ensure service continuity.

FIG. 5 is a schematic diagram of a first embodiment of a method for supporting handover according to the disclosure. The embodiment is used for handover from EN-DC (EUTRA-NR dual-connectivity) to EN-DC. A detailed description of steps unrelated to the disclosure is omitted here. The method includes the following steps.

In step 500a, a source eNB (S-eNB) sends a secondary node modification request message to a source SN (S-SN). The message includes an identification of a target eNB (T-eNB). According to the identification of the target eNB, the source SN determines whether a direct forwarding path between the source SN and the target eNB is available, and if it is available, the source SN sends information that direct forwarding paths are available to the source eNB.

The source eNB node (S-eNB) may also be called source base station or source master base station. The target eNB node (T-eNB) may also be called target base station or target master base station. The source SN node (S-SN) may also be called source secondary node. The target SN node (T-SN) may also be called target secondary node.

In step 500b, the source SN sends a secondary node modification request acknowledge message to the source eNB. If there is a direct forwarding path between the source SN and the target eNB, the message includes information that the direct forwarding path between the source SN and the target eNB is available.

Corresponding to Method 1 for determining the direct data forwarding path between the source SN and the target MN in the disclosure, step 500a and step 500b are performed. Corresponding to Method 2 for determining the direct data forwarding path between the source SN and the target MN in the disclosure, step 500a and step 500b need not be performed. It is started directly from step 501.

In step 501, the source eNB sends a handover required message to a source mobility management entity. The message includes a Source to Target transparent transmitter. The message includes information that direct data forwarding paths are available. The message includes Direct Forwarding Path Availability when the direct data forwarding path between the source eNB and the target base station is available. The message includes identification of the source eNB and identification of the source SN. When the message includes information that direct data forwarding paths are available, it includes the identification of the source eNB and the identification of the source SN. The identification of the source eNB and the identification of the source SN specifically are the same as those in step 301, and will not be repeated here. The identification of the source eNB and the identification of the source SN may be contained in a Source to Target transparent transmitter. The Source to Target transparent transmitter herein is a transparent transmitter from the source eNB to the target eNB node.

The handover required message further includes information of one or more E-RABs to be established by the target node, and the E-RAB information includes a E-RAB identification, information on downlink data forwarding and/or information on whether the E-RAB is terminated at the source master base station or at the source secondary base station. The information of the one or more E-RABs may be contained in a Source to Target transparent transmitter, or in the handover required message, or in both the handover required message and the Source to Target transparent transmitter. In this embodiment, the Source to Target transparent transmitter is a transparent transmitter from the source eNB node to the target eNB node. Information on whether the E-RAB is terminated at the master base station or at the secondary base station may be contained in the handover required message when the direct data forwarding path between the source eNB and the target eNB is unavailable. If the information is directly contained in the handover required message, the source mobility management entity will store the received information after receiving it.

In step 502, the source mobility management entity sends a forward relocation request message to the target mobility management entity. The message includes identification of the source eNB and identification of the source SN. The identification of the source eNB and the identification of the source SN may be contained in a Source to Target transparent transmitter.

The message may further include information of one or more E-RABs, and the E-RAB information is the same as that in step 501, which will not be repeated here. The information of the one or more E-RABs may be contained in a Source to Target transparent transmitter.

In step 503, the target mobility management entity sends a handover request message to the T-eNB. The message includes a Source to Target transparent transmitter. The message includes identification of the source eNB and identification of the source SN. The identification of the source eNB and the identification of the source SN may be contained in a Source to Target transparent transmitter. The Source to Target transparent transmitter herein is a transparent transmitter from the source eNB to the target eNB.

The message may further include information of one or more E-RABs to be established by the target node, and the E-RAB information is the same as that in step 501, which will not be repeated here. The information of the one or more E-RABs may be contained in a Source to Target transparent transmitter.

If the target eNB accepts the downlink data forwarding, the target eNB also needs to allocate downlink data forwarding tunnel information for the E-RAB terminated at the target eNB on the target side. The allocated downlink data forwarding tunnel information is included in a handover request acknowledge message. The target eNB determines whether there is a direct data forwarding path between the target eNB and the source SN through the identification information of the source SN. That the direct data forwarding path between the target eNB and the source SN is available is included in the handover request acknowledge message.

In step 504, the T-eNB sends a secondary node addition request message to the T-SN. The message includes source eNB identification and source SN identification information, and information of one or more E-RABs terminated at the target SN on the target side. The E-RAB information is the same as that of 501, which will not be repeated here. If the target SN accepts downlink data forwarding or the target SN proposes uplink data forwarding, the target SN also needs to allocate downlink data forwarding tunnel information and/or allocate uplink data forwarding tunnel information (if the target SN proposes uplink data forwarding) for the E-RAB terminated at the target SN on the target side. The target SN determines whether there is a direct data forwarding path between the target SN and the source eNB and the source SN, from the source eNB identification and the source SN identification information. The target SN sends the information that the direct data forwarding path between the target SN and the source eNB is available and/or the information that the direct data forwarding path between the target SN and the source SN is available, the downlink data forwarding tunnel information and/or the uplink data forwarding tunnel information allocated by the target SN to the target eNB through the secondary node addition request acknowledge message.

In step 505, the T-eNB receives a secondary node addition request acknowledge message from the T-SN. The information contained in the message corresponding to Method 1 of the disclosure is the same as that in step 303, and the specific way for the target eNB to allocate the data forwarding tunnel information is the same as that in step 303, which will not be repeated here. The information contained in the message corresponding to Method 2 of the disclosure is the same as that in step 403, and the specific way for the target eNB to allocate the data forwarding tunnel information is the same as that in step 403, which will not be repeated here.

In step 506, the T-eNB sends a handover request acknowledge message to the target mobility management entity. The information contained in the message corresponding to Method 1 of the disclosure is the same as that in step 304, which will not be repeated here. The information contained in the message corresponding to Method 2 of the disclosure is the same as that in step 404, which will not be repeated here.

The target eNB sends the information to the source eNB through a handover request acknowledge message from the target eNB to the core network and a handover command message from the core network to the source eNB. The target eNB sends the information to the source eNB through a Target to Source transparent transmitter in the handover request acknowledge message and the handover command message, or the target eNB directly includes the information in the handover request acknowledge message and the handover command message.

In step 507, the target mobility management entity sends a forward relocation response message to the source mobility management entity. The message includes a Target to Source transparent transmitter. The message includes the information sent by the target eNB to the source eNB in step 506, and the information may also be contained in the Target to Source transparent transmitter.

In step 508, the target mobility management entity sends a handover command message to the source eNB. The message includes a Target to Source transparent transmitter. The message includes the information sent by the target eNB to the source eNB in step 506, and the information may also be contained in the Target to Source transparent transmitter.

For an E-RAB terminated at the source eNB, the source eNB forwards data according to the received data forwarding tunnel information.

For an E-RAB terminated at the source SN, the behavior of the source MN corresponding to Method 1 of the disclosure is the same as that in step 305, which will not be repeated here. The behavior of the source MN corresponding to Method 2 of the disclosure is the same as that in step 405, which will not be repeated here.

In step 509, the source eNB sends a secondary node release request message to the source SN. The message includes data forwarding tunnel information. The data forwarding tunnel information is allocated by the source eNB or received by the source eNB, specifically as described in step 508. The source SN forwards data according to the data forwarding path provided by the source eNB.

In step 510, the source eNB receives a secondary node release request acknowledge message from the source SN.

In step 511, the source eNB node sends a handover command message to the UE.

The source node forwards data. The source node forwards data to the corresponding data forwarding tunnel.

In step 512, the UE sends a handover complete message to the target eNB node.

In step 513, other procedures of handover are performed.

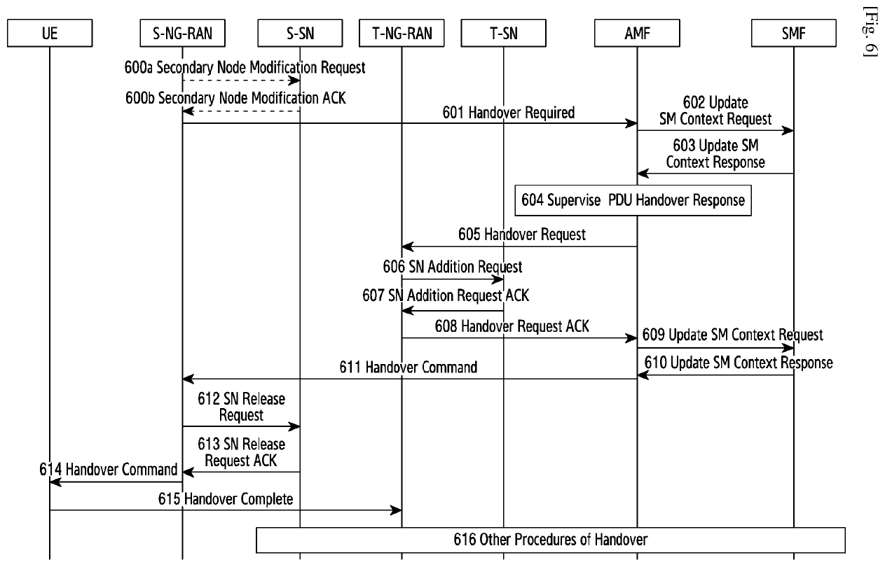

FIG. 6 shows a schematic diagram of a second embodiment of a method for supporting handover according to the disclosure. The embodiment is used for intra 5GS handover from dual-connectivity to dual-connectivity. A detailed description of steps unrelated to the disclosure is omitted here. The method includes the following steps.

In step 600a, a source NG-RAN (S-NG-RAN) sends an SN modification request message to a source SN (S-SN). The message includes an identification of a target NG-RAN (T-NG-RAN) node. According to the identification of the target NG-RAN, the source SN determines whether a direct forwarding path between the source SN and the target NG-RAN is available, and if it is available, the source SN sends information that direct forwarding paths are available to the source NG-RAN.

The NG-RAN node herein may be a NG-RAN or an eNB connected to 5GC or a centralized unit (CU) in the NG-RAN. The eNB connected to 5GC may also be called ng-eNB.

The source NG-RAN node (S-NG-RAN) may also be called source base station or source master base station. The target NG-RAN node (T-NG-RAN) may also be called target base station or target master base station. The source SN node (S-SN) may also be called source secondary node. The target SN node (T-SN) may also be called target secondary node.

The source NG-RAN node herein may be a NG-RAN or the centralized unit CU in the NG-RAN.

In step 600b, the source SN sends an SN modification request acknowledge message to the source NG-RAN. If there is the direct forwarding path between the source SN and the target NG-RAN, the message includes information that the direct forwarding path between the source SN and the target NG-RAN is available.

Corresponding to Method 1 for determining the direct data forwarding path between the source SN and the target MN in the disclosure, step 600a and step 600b are performed. Corresponding to Method 2 for determining the direct data forwarding path between the source SN and the target MN in the disclosure, step 600a and step 600b do not need to be performed. It is started directly from step 601.

In step 601, the source NG-RAN node sends a handover required message to an AMF. The message includes a Source to Target transparent transmitter. The message includes information that direct data forwarding paths are available. The message includes Direct Forwarding Path Availability when the direct data forwarding path between the source NG-RAN node and the target NG-RAN is available. The information of Direct Forwarding Path Availability may be contained in SM N2 information in the handover required message. The message includes the identifications of the source NG-RAN and the source SN. The message includes the identifications of the source NG-RAN and the source SN when the message includes the information that direct data forwarding paths are available. The identifications of the source NG-RAN and the source SN specifically are the same as those in step 301, and will not be repeated here. The identifications of the source NG-RAN and the source SN may be contained in a Source to Target transparent transmitter. The Source to Target transparent transmitter herein is a transparent transmitter from the source NG-RAN node to the target NG-RAN node.

The handover required message further includes information of one or more PDU sessions resources, and the PDU session resource includes PDU session identification, information of one or more QoS flows contained in the PDU session, information of data radio bearer (DRB) to QoS flow mapping list, and/or information that the PDU session resource is terminated at the source master base station or the source secondary base station. The information of the QoS flow further includes QoS flow identification, downlink data forwarding and uplink data forwarding information. For a split bearer, the information of the QoS flow may further include information that the QoS flow is terminated at the source master base station or the source secondary base station, or the additional PDU session resource information includes information that the PDU session resource is terminated at the source master base station or the source secondary base station. The information of DRB to QoS flow mapping includes information that the DRB is terminated at the source master base station or the source secondary base station. The information of the one or more PDU sessions resources may be contained in a Source to Target transparent transmitter, or in the handover required message, or in both the handover required message and the Source to Target transparent transmitter. The information of the one or more PDU sessions resources may be contained in a session management (SM) container of the handover required message or in both the handover required message and the SM container of the handover required message. The Source to Target transparent transmitter is a transparent transmitter from the source NG-RAN node to the target NG-RAN node. When the direct data forwarding path between the source master base station and the target master base station is unavailable, information on whether the PDU session resource is terminated at the master base station or the secondary base station, information on whether the QoS flow is terminated at the master base station or the secondary base station, and/or information on whether the DRB is terminated at the master base station or the secondary base station may be contained in the handover required message. If the information is directly contained in the handover required message, AMF will store the received information after receiving it.

The embodiment can be used for NG handover with changing the AMF or for NG handover without changing the AMF. The example of not changing the AMF is given here, but it is also applicable to the case of changing the AMF, because the disclosure does not change the interaction process between the AMFs.

In step 602, the AMF sends an update SM context request (UpdateSMContext Request) message to SMF(s). The AMF sends the message to each SMF serving the UE. The message includes information that direct data forwarding paths are available (Direct Forwarding Path Availability). The information that direct data forwarding paths are available may be contained in the SM N2 information sent by the source base station.

The message may further include information of one or more PDU sessions resources, and the PDU session resource information is the same as that in step 601, which will not be repeated here. SMF stores the received information.

The specific process between the SMF and the UPF is omitted here.

In step 603, the SMF sends an update SM context response (UpdateSMContext Response) message to the AMF. If the SMF does not receive the information that direct data forwarding paths are available and the SMF knows that there is no indirect data forwarding connection between the source and target NG-RAN nodes, the N2 SM information of the SM context response message includes “Data forwarding not possible” indication.

In step 604, the AMF supervises the update SM context response (UpdateSMContext Response) message from each involved SMF. When a maximum wait time expires or the AMF receives all the update SM context response messages, the AMF continues the handover procedure.

In step 605, the AMF sends a handover request message to the target NG-RAN node. The message includes a Source to Target transparent transmitter. The message includes a source MN identification and a source SN identification. The source MN identification and the source SN identification may be contained in a Source to Target transparent transmitter. The Source to Target transparent transmitter here is a transparent transmitter from the source NG-RAN to the target NG-RAN.

The message further includes information of one or more PDU sessions resources to be established by the target node. The PDU session resource information is the same as that in step 601, which will not be repeated here.

For a QoS flow for which data forwarding is accepted or a DRB for which data forwarding is accepted by the target NG-RAN, the target NG-RAN allocates downlink data forwarding tunnel information, and the allocated downlink data forwarding tunnel information is contained in the handover request acknowledge message. For the QoS flow for which data forwarding is accepted by the target NG-RAN, the NG-RAN allocates downlink data forwarding tunnel information for the PDU session to which the QoS flow belongs. For the DRB for which data forwarding is accepted, the target NG-RAN allocates downlink data forwarding tunnel information for the DRB.

If the target NG-RAN node receives the identification of the source SN, the target NG-RAN node judges whether the direct data forwarding path between the source SN and the target NG-RAN is available or the direct data forwarding is available. If the direct data forwarding path is available, the target NG-RAN node will include the information that the direct data forwarding path between the source SN and the target base station is available or the direct data forwarding is available in the handover request acknowledge message.

In step 606, the target NG-RAN sends an SN addition request message to the target SN. The message includes the source MN identification, the source SN identification, and information of one or more PDU sessions resources that are terminated at the target SN on the target side. The specific content of PDU session resource information is the same as that in step 601, which will not be repeated here.

For a QoS for which data forwarding is accepted by the target SN, the target SN allocates data forwarding tunnel information for the PDU session to which the QoS flow belongs. For a DRB for which data forwarding is accepted, the target SN allocates data forwarding tunnel information for the DRB. According to the source NG-RAN identification and the source SN identification, the target SN determines whether there is a direct data forwarding path between the target SN and the source NG-RAN and whether there is a direct data forwarding path between the target SN and the source SN.

The target SN sends the information that the direct data forwarding path between the target SN and the source NG-RAN is available and/or the information on that a direct data forwarding path between the target SN and the source SN is available and the data forwarding tunnel information allocated by the target SN to the target NG-RAN through a secondary node addition request acknowledge message.

In step 607, the target NG-RAN receives an SN addition request acknowledge message from the target SN. The information contained in the message corresponding to Method 1 of the disclosure is the same as that in step 303, and the specific way for the target eNB to allocate the data forwarding tunnel information is the same as that in step 303, which will not be repeated here. The information contained in the message corresponding to Method 2 of the disclosure is the same as that in step 403, and the specific way for the target eNB to allocate the data forwarding tunnel information is the same as that in step 403, which will not be repeated here. In step 608, the target NG-RAN node sends a handover request acknowledge message to the AMF. The information contained in the message corresponding to Method 1 of the disclosure is the same as that in step 304, which will not be repeated here. The information contained in the message corresponding to Method 2 of the disclosure is the same as that in step 404, which will not be repeated here.

The information may also be contained in a Target to Source transparent transmitter of the handover request acknowledge message, or in both the handover request acknowledge message and the Target to Source transparent transmitter of the handover request acknowledge message at the same time.

In step 609, the AMF sends an update SM context request (UpdateSMContext Request) message to the SMF. If the information of a data forwarding tunnel is received from the target NG-RAN node, the AMF sends the data forwarding tunnel information received from the target NG-RAN node to the SMF. The data forwarding tunnel information is the same as that in step 608, which will not be repeated here.

If the SMF receives the data forwarding tunnel information, for indirect data forwarding, the SMF or UPF allocates information of a data forwarding tunnel from the source base station to UPF. The data forwarding tunnel information in the disclosure includes a transport layer address and a tunnel identification. If the SMF receives that direct data forwarding paths are available in step 602, it is direct data forwarding. Otherwise, the SMF determines whether indirect data forwarding is available in step 603. A detailed description of the process between the SMF and UPF is omitted here.

If the SMF does not receive that direct forwarding paths are available in step 602, and the SMF receives that the direct data forwarding path between the source SN and the target MN is available from the target MN, for a PDU session or DRB terminated at the source SN, it is direct data forwarding, and the SMF does not need to allocate an indirect data forwarding tunnel for the PDU session or DRB, or the SMF does not need to request UPF to allocate an indirect data forwarding tunnel for the PDU session or DRB. For a PDU session or DRB terminated at the source master base station, the SMF or UPF allocates an indirect data forwarding data channel for the PDU session or DRB. If the SMF does not receive that direct forwarding paths are available in step 602, and the SMF receives that the direct data forwarding path between the source SN and the target base station is unavailable from the target base station or the SMF does not receive that the direct data forwarding path between the source SN and the target base station is available from the target base station, the SMF or UPF allocates the indirect data forwarding tunnel. According to the information received in the message in step 602, the SMF knows whether each PDU session and/or each DRB is terminated at the source master base station or terminated at the source secondary base station.

In step 610, the SMF sends an update SM context response (UpdateSMContext Response) message to the AMF. The SMF sends information of a data forwarding tunnel to the AMF. The information of thee data forwarding tunnel is contained in N2 SM information. Corresponding to direct data forwarding, the SMF includes the received data forwarding tunnel information in the N2 SM information, where the data forwarding tunnel information is allocated by the target base station. Corresponding to indirect data forwarding, the SMF sends data forwarding tunnel information allocated by the SMF or UPF to the AMF, where the tunnel information is used for data forwarding between the source base station and the UPF.

Corresponding to direct data forwarding, the SMF sends the tunnel information received from the AMF in step 609 to the AMF, where the tunnel information is allocated by the target NG-RAN. Corresponding to indirect data forwarding, the SMF sends tunnel information allocated by the SMF or UPF to the AMF, where the tunnel information is used for data forwarding between the source base station (including source master base station and source secondary base station) and the UPF.

The message may contain both the direct data forwarding tunnel information and indirect data forwarding tunnel information at the same time. For example, it is direct data forwarding tunnel information for one or more PDU sessions or DRBs therein, and it is indirect data forwarding tunnel information for another one or more PDU sessions or DRBs therein.

In step 611, the AMF sends a handover command message to the source NG-RAN node. The message includes a Target to Source transparent transmitter. The message includes the information sent by the target eNB to the source eNB in step 608, and the information may also be contained in the Target to Source transparent transmitter.

For a QoS flow and/or DRB terminated at the source NG-RAN, the source NG-RAN forwards data according to the received data forwarding tunnel information.

For a QoS flow and/or DRB terminated at the source SN, the behavior of the source MN corresponding to Method 1 of the disclosure is the same as that in step 305, which will not be repeated here. The behavior of the source MN corresponding to Method 2 of the disclosure is the same as that in step 405, which will not be repeated here.

In step 612, the source NG-RAN node sends an SN release request message to the source SN.

In step 613, the source SN sends an SN release request acknowledge message to the source NG-RAN node.

In step 614, the source NG-RAN node sends a handover command message to the UE.

The source node forwards data. The source node forwards data to the corresponding data forwarding tunnel.

In step 615, the UE sends a handover complete message to the target NG-RAN node.

In step 616, other procedures of handover are performed.

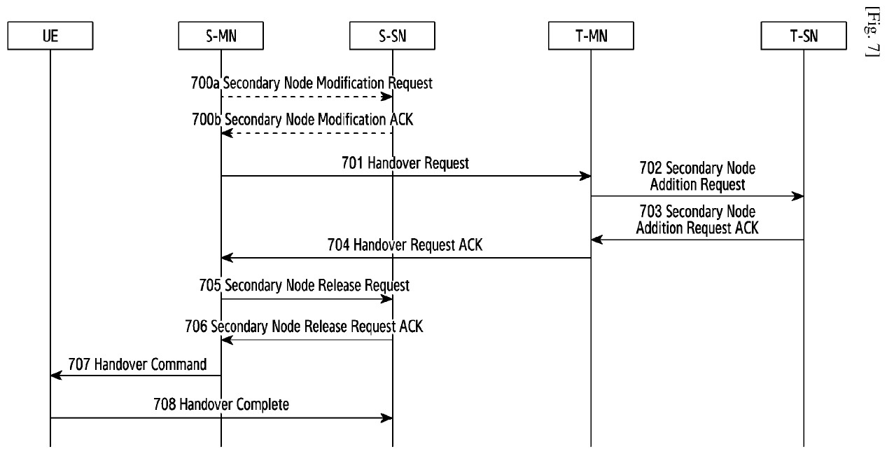

FIG. 7 shows a schematic diagram of a third embodiment of a method for supporting handover according to the disclosure. The embodiment is used for a source master base station and a target master base station to send a handover message over a Xn/X2 interface, so as to solve a problem about whether to perform direct data forwarding or indirect data forwarding in a process of handover from dual-connectivity to dual-connectivity. The embodiment may be used for handover from EN-DC (EUTRA-NR dual-connectivity) to EN-DC, and may also be used for intra 5GS handover from dual-connectivity to dual-connectivity. The method includes the following steps.

In step 700a, a source MN (S-MN) sends an SN modification request message to a source SN (S-SN). The message includes an identification of a target MN (T-MN). According to the identification of the target MN, the source SN determines whether a direct forwarding path between the source SN and the target MN is available, and if it is available, the source SN sends information that the direct forwarding path is available to the source MN.

The source MN node (MN) may also be called source base station or source master base station. The target node (T-MN) may also be called the target base station or the target master base station. The source SN node (S-SN) may also be called source secondary node. The target SN node (T-SN) may also be called target secondary node.

The source MN source node may be an eNB, or a gNB or a centralized unit (CU) in the gNB.

The MN target node may be an eNB, or a gNB or a CU in the gNB.

In step 700b, the source SN sends an SN modification request acknowledge message to the source MN. If there is the direct forwarding path between the source SN and the target MN, the message includes the information that the direct forwarding path between the source SN and the target MN is available.

Corresponding to Method 1 for determining the direct data forwarding path between the source SN and the target MN in the disclosure, step 700a and step 700b are performed. Corresponding to Method 2 for determining the direct data forwarding path between the source SN and the target MN in the disclosure, step 700a and step 700b need not be performed. It is started directly from step 701.

In step 701, the source MN sends a handover request message to the target MN. The message includes a source MN identification and a source SN identification, and the source MN sends the source MN identification and the source SN identification to the target MN. The source MN identification and the source SN identification specifically are the same as those in step 301, and will not be repeated here.

For an EN-DC to EN-DC handover, the handover request message needs to contain information of one or more E-RABs, and the E-RAB information includes E-RAB identification, and information on downlink data forwarding and/or information on whether the E-RAB is terminated at the source master base station or the source secondary base station.

For an intra 5GS handover from dual-connectivity to dual-connectivity, the handover request message further includes information of one or more PDU sessions resources, and the PDU session resource includes PDU session identification, information of one or more QoS flows contained in the PDU session, information of data radio bearer (DRB) to QoS flow mapping list, and/or information that the PDU session resource is terminated at the source master base station or the source secondary base station. The information of the QoS flows further includes QoS flow identification, downlink data forwarding and uplink data forwarding information. The information of DRB to QoS flow mapping includes information that the DRB is terminated at the source master base station or the source secondary base station.

In step 702, the target MN sends a secondary node addition request message to the target SN. This step is the same as step 504 for the handover from EN-DC to EN-DC, and this step is the same as step 606 for the intra 5GS handover from dual-connectivity to dual-connectivity, which will not be repeated here.

In step 703, the target SN sends a secondary node addition request acknowledge message to the target MN. The information contained in the message corresponding to Method 1 of the disclosure is the same as that in step 303, and the specific way for the target eNB to allocate the data forwarding tunnel information is the same as that in step 303, which will not be repeated here. The information contained in the message corresponding to Method 2 of the disclosure is the same as that in step 403, and the specific way for the target eNB to allocate the data forwarding tunnel information is the same as that in step 403, which will not be repeated here.

In step 704, the target MN sends a handover request acknowledge message to the source MN.

For a bearer terminated at the source MN, the source MN forwards data according to the received data forwarding tunnel information.

For a bearer terminated at the source SN, the behavior of the source MN corresponding to Method 1 of the disclosure is the same as that in step 305, which will not be repeated here. The behavior of the source MN corresponding to Method 2 of the disclosure is the same as that in step 405, which will not be repeated here.

In step 705, the source MN sends a secondary node release request message to the source SN. This step is the same as step 509 for the handover from EN-DC to EN-DC, and this step is the same as step 612 for the intra-5GS handover from dual-connectivity to dual-connectivity, which will not be repeated here.

In step 706, the source SN sends a secondary node release request acknowledge message to the source MN. This step is the same as step 510 for the handover from EN-DC to EN-DC, and this step is the same as step 613 for the intra 5GS handover from dual-connectivity to dual-connectivity, which will not be repeated here.

In step 707, the source MN sends a handover command message to the UE.

The source node forwards data. The source node forwards data to the corresponding data forwarding tunnel.

In step 708, the UE sends a handover complete message to the target MN node.

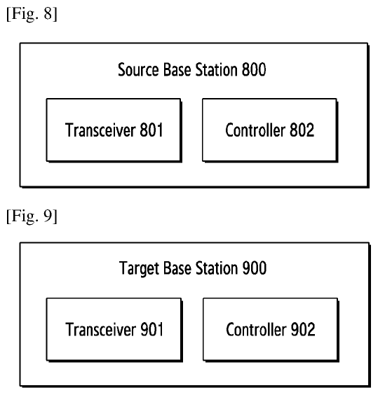

FIG. 8 shows a block diagram of a source base station for a method for supporting handover according to an embodiment of the disclosure.

Referring to FIG. 8, the source base station 800 may include a transceiver 801 and a controller 802.

The transceiver 801 may be configured to send a source MN identification and a source SN identification to a target base station, receive data forwarding tunnel information, and send a secondary base station release request message to a source SN.

The controller 802 may be a circuit specific integrated circuit or at least one processor. The controller 802 may be configured to control the overall operation of the source base station and to control the source base station to implement the method proposed in the disclosure. Specifically, the controller 802 may be configured to control the transceiver 801 to send the source MN identification and the source SN identification to the target base station, receive the data forwarding tunnel information, and send the secondary base station release request message to the source SN.

So far, the description of the source base station or the source master base station for the method for supporting handover of the disclosure has been completed. By means of the source base station or the source master base station, it can solve a problem about whether to perform direct data forwarding or indirect data forwarding in a process of handover from dual-connectivity to dual-connectivity, ensure coordinated work of the source master base station, source secondary base station, target master base station, target secondary base station and core network, avoid influence on the core network, reduce data loss, reduce data interruption time, improve data forwarding efficiency and ensure service continuity.

FIG. 9 shows a block diagram of a target base station for a method for supporting handover according to an embodiment of the disclosure.

Referring to FIG. 9, the target base station 900 may include a transceiver 901 and a controller 902.

The transceiver 901 may be configured to receive a source master base station identification and a source secondary base station identification from a source master base station, and to send information that a direct data forwarding path between a source secondary base station and the target base station is available and/or information that a direct data forwarding path between the source master base station and a target secondary base station is available and/or information that a direct data forwarding path between the source secondary base station and the target secondary base station is available to the source master base station.

The controller 902 may be a circuit specific integrated circuit or at least one processor. The controller 902 may be configured to control the overall operation of the target base station and control the target base station to implement the method proposed in the disclosure. Specifically, the controller 902 may be configured to control the transceiver 901 to receive the source master base station identification and the source secondary base station identification from the source master base station, and to send the information that the direct data forwarding path between the source secondary base station and the target base station is available and/or the information that the direct data forwarding path between the source master base station and the target secondary base station is available and the information that the direct data forwarding path between the source secondary base station and the target secondary base station is available to the source master base station.

So far, the description of the target base station or the target master base station for the method for supporting handover of the disclosure has been completed. By means of the target base station, it can solve a problem about whether to perform direct data forwarding or indirect data forwarding in a process of handover from dual-connectivity to dual-connectivity, ensure coordinated work of the source master base station, source secondary base station, target master base station, target secondary base station and core network, avoid influence on the core network, reduce data loss, reduce data interruption time, improve data forwarding efficiency and ensure service continuity.

Those skilled in the art will understand that various illustrative logical blocks, modules, circuits, and steps described in the present application can be implemented as hardware, software, or combinations of both. To clearly illustrate this interchangeability between hardware and software, various illustrative components, blocks, modules, circuits, and steps are generally described above in the form of their function sets. Whether such a function set is implemented as hardware or software depends on the specific application and the design constraints imposed on the overall system. Technicians can implement the described function sets in different ways for each specific application, but such design decisions should not be interpreted as causing a departure from the scope of the present application.

The various illustrative logic blocks, modules, and circuits described in the present application can be implemented or performed with a general-purpose processor, a digital signal processor (DSP), an application specific integrated circuit (ASIC), a field programmable gate array (FPGA) or other programmable logic devices, discrete gate or transistor logic, discrete hardware components, or any combination thereof designed to perform the functions described herein. The general-purpose processor may be a microprocessor, but in the alternative, the processor may be any conventional processor, controller, microcontroller, or state machine. The processor can also be implemented as a combination of computing devices, such as a combination of a DSP and a microprocessor, a plurality of microprocessors, one or more microprocessors cooperating with a DSP core, or any other such configuration.

The steps of the method or algorithm described in the present application can be directly embodied in hardware, in a software module performed by a processor, or in a combination of both. The software modules may reside in RAM memory, flash memory, ROM memory, EPROM memory, EEPROM memory, registers, hard disks, removable disks, or any other form of storage media known in the art. An exemplary storage medium is coupled to the processor so that the processor can read and write information from/to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

In one or more exemplary designs, the functions can be implemented in hardware, software, firmware, or any combination thereof. If implemented in software, each function can be stored on or transmitted by a computer-readable medium as one or more instructions or codes. Computer-readable media include both computer storage media and communication media, the latter including any media that facilitates the transfer of computer programs from one place to another. Storage media may be any available media that can be accessed by general-purpose or special-purpose computers.

The embodiments of the present application are only for easy description and help to fully understand the present application, and are not intended to limit the scope of the present application. Therefore, it should be understood that, except for the embodiments disclosed herein, all modifications and changes or forms of modifications and changes derived from the technical concept of the present application fall within the scope of the present application.

1.-15. (canceled)

16. A method performed by a target master node (MN) in a wireless communication system, the method comprising:
receiving, from a source MN, a first message including first information on a first identity related to the source MN and second information on a second identity related to a source secondary node (SN);
transmitting, to a target SN, a second message including the first information, the second information, and third information related to a bearer terminated at the target SN;
receiving, from the target SN, a third message including fourth information on a direct forwarding path availability; and
transmitting, to the source MN, a fourth message including the fourth information and fifth information on a data forwarding tunnel.

17. The method of claim 16,
wherein the fourth information includes at least one of a first direct forwarding path availability between the source MN and the target SN, or a second direct forwarding path availability between the source SN and the target SN.

18. The method of claim 16,
wherein the fifth information includes information on a data forwarding tunnel associated with the target MN and information on a data forwarding tunnel associated with a target SN.

19. The method of claim 18,
wherein the information on the data forwarding tunnel associated with the target MN includes first uplink (UL) forwarding tunnel information and first downlink (DL) forwarding tunnel information, and
wherein the information on the data forwarding tunnel associated with the target SN includes second UL forwarding tunnel information and second DL forwarding tunnel information.

20. The method of claim 16,
wherein the first message includes a handover request message,
wherein the second message includes a secondary node addition request message,
wherein the third message includes a secondary node addition request acknowledge message, and
wherein the fourth message includes a handover request acknowledge message.

21. A method performed by a source master node (MN) in a wireless communication system, the method comprising:
transmitting, to a target MN, a first message including first information on a first identity related to the source MN and second information on a second identity related to a source secondary node (SN); and
receiving, from the target MN, a second message including third information on a direct forwarding path availability and fourth information on a data forwarding tunnel.

22. The method of claim 21,
wherein the third information includes at least one of a first direct forwarding path availability between the source MN and a target SN, or a second direct forwarding path availability between the source SN and the target SN.

23. The method of claim 21,
wherein the fourth information includes information on a data forwarding tunnel associated with the target MN and information on a data forwarding tunnel associated with a target SN.

24. A method performed by a target secondary node (SN) in a wireless communication system, the method comprising:
receiving, from a target master node (MN), a first message including first information on a first identity related to a source MN, second information on a second identity related to a source SN, and third information related to a bearer terminated at the target SN;
determining fourth information on a direct forwarding path availability; and
transmitting, to the target MN, a second message including the fourth information.

25. The method of claim 24,
wherein the fourth information includes at least one of a first direct forwarding path availability between the source MN and the target SN, or a second direct forwarding path availability between the source SN and the target SN, and
wherein the fourth information is determined based on the first information and the second information.

26. A target master node (MN) in a wireless communication system, the target MN comprising:
a transceiver; and
a controller coupled with the transceiver and configured to:
receive, from a source MN, a first message including first information on a first identity related to the source MN and second information on a second identity related to a source secondary node (SN);
transmit, to a target SN, a second message including the first information, the second information, and third information related to a bearer terminated at the target SN;
receive, from the target SN, a third message including fourth information on a direct forwarding path availability; and
transmit, to the source MN, a fourth message including the fourth information and fifth information on a data forwarding tunnel.

27. The target MN of claim 26,
wherein the fourth information includes at least one of a first direct forwarding path availability between the source MN and the target SN, or a second direct forwarding path availability between the source SN and the target SN.

28. The target MN of claim 26,
wherein the fifth information includes information on a data forwarding tunnel associated with the target MN and information on a data forwarding tunnel associated with a target SN.

29. The target MN of claim 28,
wherein the information on the data forwarding tunnel associated with the target MN includes first uplink (UL) forwarding tunnel information and first downlink (DL) forwarding tunnel information, and
wherein the information on the data forwarding tunnel associated with the target SN includes second UL forwarding tunnel information and second DL forwarding tunnel information.

30. The target MN of claim 26,
wherein the first message includes a handover request message,
wherein the second message includes a secondary node addition request message,
wherein the third message includes a secondary node addition request acknowledge message, and
wherein the fourth message includes a handover request acknowledge message.

31. A source master node (MN) in a wireless communication system, the source MN comprising:
a transceiver; and
a controller coupled with the transceiver and configured to:
transmit, to a target MN, a first message including first information on a first identity related to the source MN and second information on a second identity related to a source secondary node (SN); and
receive, from the target MN, a second message including third information on a direct forwarding path availability and fourth information on a data forwarding tunnel.

32. The source MN of claim 31,
wherein the third information includes at least one of a first direct forwarding path availability between the source MN and a target SN, or a second direct forwarding path availability between the source SN and the target SN.

33. The source MN of claim 31,
wherein the fourth information includes information on a data forwarding tunnel associated with the target MN and information on a data forwarding tunnel associated with a target SN.

34. A target secondary node (SN) in a wireless communication system, the target SN comprising:
a transceiver; and
a controller coupled with the transceiver and configured to:
receive, from a target master node (MN), a first message including first information on a first identity related to a source MN, second information on a second identity related to a source SN, and third information related to a bearer terminated at the target SN;
determine fourth information on a direct forwarding path availability; and
transmit, to the target MN, a second message including the fourth information.

35. The target SN of claim 34,
wherein the fourth information includes at least one of a first direct forwarding path availability between the source MN and the target SN, or a second direct forwarding path availability between the source SN and the target SN, and
wherein the fourth information is determined based on the first information and the second information.
